(19) United States
(12) Patent Application Publication
(10) Pub. No.: US 2008/0104411 A1
(43) Pub. Date: May 1, 2008

(54) Methods and apparatus for changing passwords in a distributed communication system

(76) Inventors: Pankaj O. Agrawal, Broomfield, CO (US); Albert J. Baker, Brick, NJ (US); Daniel Kaiser, Denver, CO (US); Marcus V. Roman, Louisville, CO (US)

Correspondence Address: RYAN, MASON & LEWIS, LLP, 1300 POST ROAD, SUITE 205, FAIRFIELD, CT, 06824, US

(21) Appl. No.: 11/541,097

(22) Filed: Sep. 29, 2006

(51) Int. Cl. H04L 9/32; H04L 9/00; G06F 17/30; H04K 1/00; G06F 15/16; G06F 7/04; G06F 7/58; G06K 19/00; G06K 9/00

(52) U.S. Cl. 713/183; 726/6

(57) ABSTRACT

Methods and apparatus are provided for changing passwords in a distributed communication system. The disclosed password management system includes an event server for receiving one or more subscriptions to a password change event from one or more endpoints associated with a user and for notifying the endpoints that subscribed to the password change event of a password change; and a profile service for (i) receiving a request for a new password from one or more of the endpoints in response to the subscription notification from the event server of the password change event; (ii) authenticating the one or more of the endpoints based on an existing password; and (iii) providing a new password to the one or more of the endpoints following the authentication. A password manager notifies the event server and profile service of a password change.

### FIELD OF THE INVENTION

The present invention relates generally to password management techniques, and more particularly, to techniques for managing the password for one or more user devices in a distributed communication system.

### BACKGROUND OF THE INVENTION

Communication systems have quickly evolved from legacy telephone systems where a single user typically had a single hard-wired telephone extension to more flexible communication systems where users have multiple devices. In Internet Protocol (IP) telephony systems or Session Initiation Protocol (SIP) systems, for example, a user is typically a logical entity that may have one or more devices. A user can often now obtain service from any telephone or a number of different applications, such as soft clients on a personal computer or instant messaging (IM) clients.

When users have multiple devices, it is important to manage the access control or login credentials of each endpoint. This problem is even more apparent for devices that do not have a convenient mechanism for entering characters for the password. For example, it is difficult to reliably enter letters or special characters on a typical telephone key pad, especially if case sensitivity is required. As business processes and applications increasingly focus on security, the telephone is often considered as the most unsecured portion of the system, since the telephone password is a series of digits, often equivalent to that of the telephone extension number. Furthermore, the user interface on the telephone for changing a user password is unintuitive to the end user.

A number of techniques have been proposed or suggested for the management of passwords. The advance of Voice Over IP (VoIP) communications has required that a telephone must have a password before it can even make a telephone call. Legacy telephones, however, do not have passwords. A legacy telephone is typically hardwired and specifically configured at a location for a given extension.

The advance of SIP has further increased the need for secure password management. With SIP, a user with a single identity (e.g., joe@avaya.com) and multiple endpoints (such as a desk telephone, a Softphone, a cell phone and an IM client) must authenticate each endpoint individually to communicate with the system. Additionally, SIP lends itself to mobility, so the authentication must occur for a user on each device for the time that the user is registered on the device. The opportunity for spoofing attacks or for an unauthorized user to gain access to the system is much easier if the system relies on the user to manually change passwords on his or her set of devices.

A need therefore exists for improved techniques that allow a user to securely manage a plurality of devices without having to manually intervene and enter passwords multiple times in the devices. A further need exists for improved methods and apparatus for changing passwords in a distributed communication system.

### SUMMARY OF THE INVENTION

Generally, methods and apparatus are provided for changing passwords in a distributed communication system. According to one aspect of the invention, the disclosed password management system includes an event server for receiving one or more subscriptions to a password change event from one or more endpoints associated with a user and for notifying the endpoints that subscribed to the password change event of a password change; and a profile service for (i) receiving a request for a new password from one or more of the endpoints in response to the subscription notification from the event server of the password change event; (ii) authenticating the one or more of the endpoints based on an existing password; and (iii) providing a new password to the one or more of the endpoints following the authentication.

A disclosed password manager notifies the event server of a password change and the event server processes one or more subscriptions to a password change event from one or more of the endpoints associated with the user. In addition, the password manager notifies the profile service of the password change and the profile service receives a request for a new password from one or more of the endpoints in response to a subscription notification from the event server of a password change event; and provides a new password to the one or more of the endpoints following an authentication procedure.

An event server in accordance with the present invention receives one or more subscriptions to a password change event from one or more of the endpoints associated with the user; receives a notification of a password change from a password manager; and notifies the endpoints that subscribed to the password change event of the password change, wherein the notification triggers one or more of the endpoints to authenticate to a profile service to obtain a new password.

A profile service in accordance with the present invention receives a request for a new password from one or more of the endpoints in response to a subscription notification from an event server of a password change event; authenticates the one or more of the endpoints based on an existing password; and provides a new password to the one or more of the endpoints following the authentication.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of a password manager architecture incorporating features of the present invention; and

FIG. 2 is a flow chart describing an exemplary implementation of a password management process incorporating features of the present invention.

### DETAILED DESCRIPTION

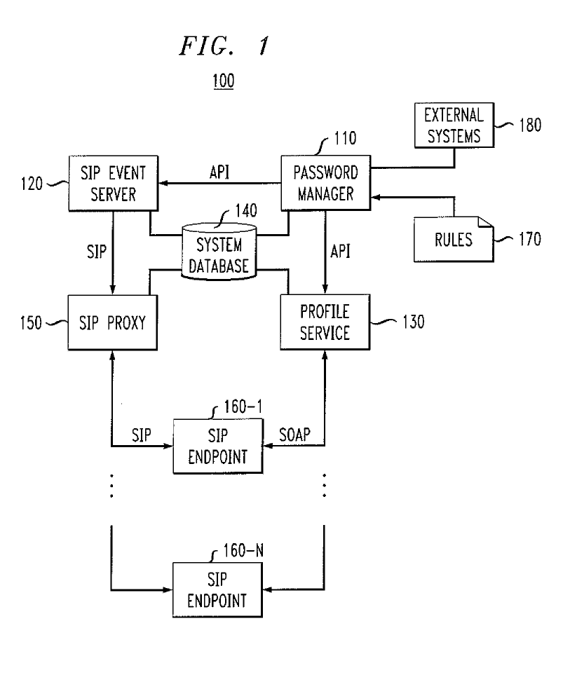

The present invention provides improved methods and apparatus for changing passwords in a distributed communication system. FIG. 1 is a block diagram of a password manager architecture 100 incorporating features of the present invention. As shown in FIG. 1, a password manager 110 manages the passwords for one or more endpoints 160-1 through 160-N associated with a user. As discussed hereinafter, the password manager 110 interacts with an event server 120 and a profile service 130, and the endpoint 160 performing a profile service action based on the notification received from the event server 120. While the exemplary embodiment is described herein in the context of SIP devices, any communication protocol can be employed, as would be apparent to a person of ordinary skill in the art.

Generally, one or more endpoints 160 associated with a user subscribe to a profile event package for receiving password change events upon the change of a password. The password change can be initiated in numerous ways. For example, the password can be changed by an external system 180, such as an identity management system or an authentication system. In addition, as discussed hereinafter, the password change can be triggered by, for example, the expiration of a current password (for example, in accordance with a business rule) or manually by an administrator or the user. In any case, the password manager 110 is notified of the password change, and the password manager 110 notifies the event server 120 to notify all endpoints that have subscribed to password change events for the user. When an endpoint 160 that has subscribed to the password change event receives the event indicating that the password has changed (or is about to change), the endpoint 160 has several ways of obtaining the new password.

The password manager 110 generally maintains a secure password database, for example, in the database 140. The password database can be indexed, for example, by a user identifier, and contain the current password for each user.

The event server 120 provides a subscription service that allows users or endpoints to subscribe to events of interest, such as the password change events associated with the present invention. The event server 120 can maintain an event database, for example, in the database 140. An entry in an exemplary event database can comprise an event type, user identifier, and the endpoints that have subscribed to the event. For the password change event, the corresponding record can identify the IP address and MAC address of the endpoints 160 that subscribed to the event. Each event is optionally transmitted through a SIP Proxy 150.

The SIP Proxy 150 typically issues a challenge whenever an endpoint 160 attempts to communicate in the SIP network. The endpoint 160 must respond to the challenge with the correct password. The profile service 130 manages and securely stores user profile information, such as buddy lists, device settings, and access control permissions.

A number of rules 170 can control when and how passwords are changed, or impose character requirements in the actual passwords. For example, a rule in the rulebase 170 can indicate that a password can only be changed upon confirmation by the user. User confirmation may be required, for example, where a user has multiple devices, or old logins that are not physically secure. For example, the user might have logged into a telephone in the lab, and the password manager 110 should not preserve that telephone being logged in after the password change. Thus, the password change confirmation allows the user to enter a simple set of digits, for example, just to confirm that they know the password is being changed and to continue.

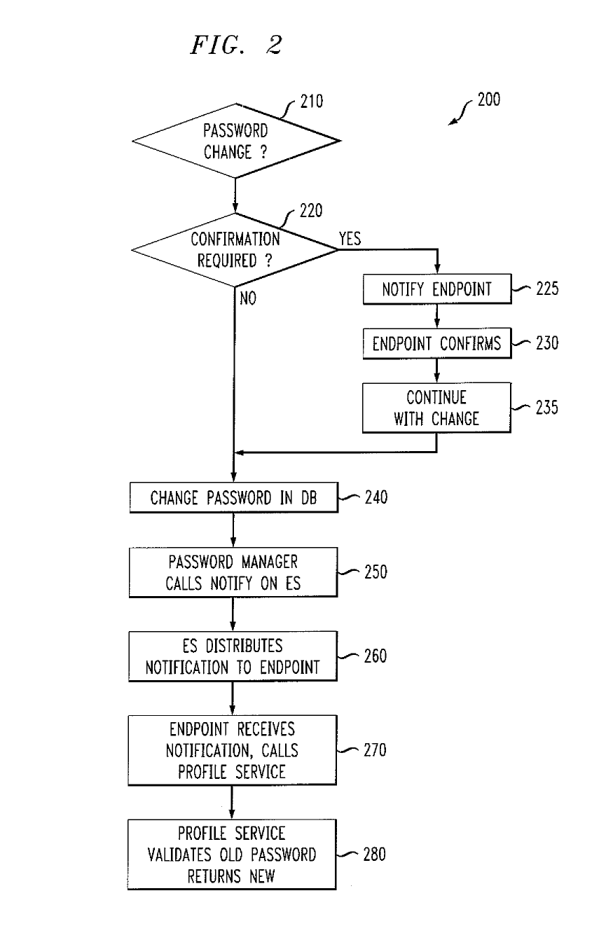

FIG. 2 is a flow chart describing an exemplary implementation of a password management process 200 incorporating features of the present invention. As shown in FIG. 2, the password management process 200 continues to monitor during step 210 until a password change is detected. Once a password change is detected in step 210, a further test is performed during step 220 to determine if a user confirmation is required to implement the password change.

If it is determined during step 220 that a user confirmation is not required to implement the password change, then program control proceeds directly to step 240, discussed below. If, however, it is determine during step 220 that a user confirmation is required to implement the password change, then the endpoint is notified of the password change during step 225. For example, an endpoint 160 can prompt the user with a user interface for entering a predefined confirmation code. Once the endpoint confirms the password change during step 230, the process 200 continues with the change during step 235, by proceeding to step 240. The password manager 110 can optionally request the event server 120 to perform the confirmation procedure with the user. In one exemplary implementation of the confirmation procedure, the password manager 110 receives a confirmation code for retrieving new passwords from the user during a registration process and the profile service 130 stores the status of the confirmation. The confirmation code can also be automatically generated and provided to the user. The confirmation can be, for example, a digit-only key that can be easily entered from a standard keypad.

During step 240, the password manager changes the password for the user in the password database 140. Thereafter, the password manager 110 informs the event server 120 of the password change for the user during step 250. The event server 120 sends out a notify message during step 260 to all endpoints 160 that subscribed to the password change event for that user.

The endpoint(s) 160 receive the notification of the password change event during step 270 and call the profile service to retrieve the new password. In one exemplary implementation, the endpoint authenticates to the profile service 130 during step 280 with the old password and the confirmation code or the current subscription to the profile event package. In other words, the IP address and MAC address associated with the request received by the profile service 130 can be compared to the address information stored in the database 140 for the password change event. Once the endpoint(s) 160 have been properly authenticated to the profile service 130 with the old password and any additional authentication that may be required, the new password is returned to the endpoints. Thereafter, the endpoint(s) 160 use the new password for all communications and authentication challenges. For example, the endpoints 160 can optionally be required to re-register and subscribe to the profile event package with the new password for any further password changes.

Upon completion of the password management process 200, the password manager 110 can delete the old password and complete the password change. Prior to this both passwords may optionally be available and usable in the system. At some point, if not all passwords have been changed, the system may optionally time out the old password.

In various implementations, a number of the above aspects can be configurable in the password manager. For example, the threshold for how long endpoints must refresh the password and the old passwords for telephones are timed out can be configured. In addition, the usage of a confirmation code for certain types of endpoints versus automatic changes to other types of endpoints can be defined (i.e., generating the notifications based on knowledge about the endpoints). The confirmation code can optionally be generated based on shared secret knowledge with the endpoint. For example, the old password, the MAC address of the endpoint, and the user's identity in the SIP (e.g., SIP primary handle) can be used to generate the confirmation code. In a further variation, a priority can be established to rank the devices for change notification. In this manner, certain devices can have their password reset immediately.

To make this service secure and to avoid spoofing attacks to either extract passwords out of the system or fool clients into taking passwords from a fake system, the following steps can be taken. First, the server and client must have a shared secret to use for encryption and decryption. This secret should be compiled into the run time systems and not viewable to the end users. In addition, the notification mechanism must either be through a secure channel to validate the event server, or contain a security token that validates that the server is trusted. This can avoid man-in-the-middle security attacks that would try to gain access to the password. Finally, when the new password is sent down in the profile service, that password must be encrypted using the shared secret in the systems. The encryption algorithm may also take a seed of the confirmation number if human intervention is required for the new password to be applied.

While the figures herein show an exemplary sequence of steps, it is also an embodiment of the present invention that the sequence may be varied. Various permutations of the algorithms are contemplated as alternate embodiments of the invention.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A password management system, comprising:
an event server for receiving one or more subscriptions to a password change event from one or more endpoints associated with a user and for notifying said endpoints that subscribed to said password change event of a password change; and
a profile service for (i) receiving a request for a new password from one or more of said endpoints in response to said subscription notification from said event server of said password change event; (ii) authenticating said one or more of said endpoints based on an existing password; and (iii) providing a new password to said one or more of said endpoints following said authentication.

2. The password management system of claim 1, wherein said profile service implements said password change only upon determining if said user has confirmed said password change.

3. The password management system of claim 2, wherein said user is prompted to enter a predefined confirmation code.

4. The password management system of claim 1, further comprising a password manager that notifies said event server of said password change.

5. The password management system of claim 1, wherein said one or more of said endpoints are authenticated using said existing password and one or more of a confirmation code and an address associated with said request.

6. A method for managing a password change for one or more endpoints associated with a user, comprising:
receiving one or more subscriptions to a password change event from one or more of said endpoints associated with said user;
receiving a notification of a password change from a password manager; and
notifying said endpoints that subscribed to said password change event of said password change, wherein said notification triggers one or more of said endpoints to authenticate to a profile service to obtain a new password.

7. The method of claim 6, wherein said password change is implemented only upon determining if said user has confirmed said password change.

8. The method of claim 7, wherein said user is prompted to enter a predefined confirmation code.

9. The method of claim 6, wherein said one or more of said endpoints are authenticated using an existing password and one or more of a confirmation code and an address associated with said request.

10. A method for managing a password change for one or more endpoints associated with a user, comprising:
receiving a request for a new password from one or more of said endpoints in response to a subscription notification from an event server of a password change event;
authenticating said one or more of said endpoints based on an existing password; and
providing a new password to said one or more of said endpoints following said authentication.

11. The method of claim 10, wherein said password change is implemented only upon determining if said user has confirmed said password change.

12. The method of claim 11, wherein said user is prompted to enter a predefined confirmation code.

13. The method of claim 10, further comprising the step of receiving a notification of said password change from a password manager.

14. The method of claim 10, wherein said event server notifies said endpoints that subscribed to said password change event for said user.

15. The method of claim 10, wherein said one or more of said endpoints are authenticated using said existing password and one or more of a confirmation code and an address associated with said request.

16. A method for managing a password change for one or more endpoints associated with a user, comprising:
providing a notification of a password change to an event server that processes one or more subscriptions to a password change event from one or more of said endpoints associated with said user; and
providing a notification of said password change to a profile service that receives a request for a new password from one or more of said endpoints in response to a subscription notification from said event server of a password change event; and provides a new password to said one or more of said endpoints following an authentication procedure.

17. The method of claim 16, wherein said password change is implemented only upon determining if said user has confirmed said password change.

18. The method of claim 17, wherein said user is prompted to enter a predefined confirmation code.

19. The method of claim 16, wherein said event server notifies said endpoints that subscribed to said password change event for said user.

20. The method of claim 16, wherein said one or more of said endpoints are authenticated using an existing password and one or more of a confirmation code and an address associated with said request.

21. A system for managing a password change for one or more endpoints associated with a user, comprising:
a memory; and
at least one processor, coupled to the memory, operative to:
receive one or more subscriptions to a password change event from one or more of said endpoints associated with said user;
receive a notification of a password change from a password manager; and
notify said endpoints that subscribed to said password change event of said password change, wherein said notification triggers one or more of said endpoints to authenticate to a profile service to obtain a new password.

22. A system for managing a password change for one or more endpoints associated with a user, comprising:
a memory; and
at least one processor, coupled to the memory, operative to:
receive a request for a new password from one or more of said endpoints in response to a subscription notification from an event server of a password change event;
authenticate said one or more of said endpoints based on an existing password; and
provide a new password to said one or more of said endpoints following said authentication.

23. A system for managing a password change for one or more endpoints associated with a user, comprising:
a memory; and
at least one processor, coupled to the memory, operative to:
provide a notification of a password change to an event server that processes one or more subscriptions to a password change event from one or more of said endpoints associated with said user; and
provide a notification of said password change to a profile service that receives a request for a new password from one or more of said endpoints in response to a subscription notification from said event server of a password change event; and provides a new password to said one or more of said endpoints following an authentication procedure.
